(19) United States
(12) Patent Application Publication
(10) Pub. No.: US 2008/0110182 A1
(43) Pub. Date: May 15, 2008

(54) Coaxial Cryogenic Refrigeration Coupler

(76) Inventors: David W. Vancelette, San Diego, CA (US); Patricia M. Derus, Rogers, MN (US)

Correspondence Address: AMS RESEARCH CORPORATION, 10700 BREN ROAD WEST, MINNETONKA, MN, 55343, US

(21) Appl. No.: 11/938,352

(22) Filed: Nov. 12, 2007

Related U.S. Application Data
(60) Provisional application No. 60/865,248, filed on Nov. 10, 2006.

(51) Int. Cl. F17C 13/00

(52) U.S. Cl. 62/50.7

(57) ABSTRACT

A cryosurgical system having a coupler for connecting a disposable cryoprobe end portion to a non-disposable cryoprobe base portion. A cryoprobe can include a disposable portion that connects via a coupler to a non-disposable portion that is permanently attached to the cryosurgical system. Once a disposable portion is attached to the cryosurgical system, refrigerant can be circulated through the system and a cryothermal treatment can be performed. Upon completion of the cryosurgical treatment, the disposable portion can be detached and discarded.

### PRIORITY CLAIM

The present application claims priority to U.S. Provisional Application Ser. No. 60/865,248, filed Nov. 10, 2006 and entitled, “COAXIAL CRYOGENIC REFRIGERATION COUPLER”, which is herein incorporated by reference in its entirety.

### FIELD OF THE INVENTION

The present disclosure relates to cryosurgical systems for medical treatment of benign or cancerous tissues. In particular, the present disclosure relates to a coupler for attaching disposable cryoprobes to a closed loop cryosurgical system.

### BACKGROUND OF THE INVENTION

Cryosurgical probes are used to treat a variety of diseases. Cryosurgical probes quickly freeze diseased body tissue, causing the tissue to die after which it will be absorbed by the body, expelled by the body, sloughed off or replaced by scar tissue. Cryothermal treatment can be used to treat both benign and cancerous tissues, e.g., prostate cancer and benign prostate disease. Cryosurgery also has gynecological applications in treatment of the uterus or fibroids. In addition, cryosurgery may be used for the treatment of a number of other diseases and conditions including, but certainly not limited to, breast cancer, liver cancer, renal cancer, glaucoma and other eye diseases.

A variety of cryosurgical instruments variously referred to as cryoprobes, cryosurgical probes, cryosurgical ablation devices, cryostats and cryocoolers have been used for cryosurgery. These devices typically use the principle of Joule-Thomson expansion to generate cooling. They take advantage of the fact that most fluids, when rapidly expanded, become extremely cold. In these devices, a high pressure gas mixture is expanded through a nozzle inside a small cylindrical shaft or sheath typically made of steel. The Joule-Thomson expansion cools the steel sheath to a cold temperature very rapidly. The cryosurgical probes then form ice balls which freeze diseased tissue. A properly performed cryosurgical procedure allows cryoablation of the diseased tissue without undue destruction of surrounding healthy tissue.

### SUMMARY OF THE INVENTION

The present disclosure is directed to a cryosurgical system and a coupler for connecting a disposable cryoprobe end portion to a non-disposable cryoprobe base portion. A representative cryoprobe for use in a cryosurgical system can have a disposable portion that connects via a coupler to a non-disposable portion that is permanently attached to the cryosurgical system. Once a disposable portion is attached to the cryosurgical system, refrigerant can be circulated through the system and a cryothermal treatment can be performed. Upon completion of the cryosurgical treatment, the disposable portion can be detached and discarded.

In one aspect of the present disclosure, a coupler can connect a disposable cryoprobe end portion to a non-disposable cryoprobe base portion. The coupler can link high pressure and low pressure refrigerant pathways of the disposable portion with high pressure and low pressure refrigerant pathways of the non-disposable portion so that refrigerant can freely flow between the disposable portion and non-disposable portion. In one representative embodiment, the coupler can comprise a pair of metal face seal fittings sealed together with a coupling nut. A metal gasket can be positioned between the face seal fittings to enhance the seal. Disposable portions can be disconnected from the system by loosening and removing the coupling nut and separating the face seal fittings.

In another aspect of the present disclosure, a cryoprobe has a disposable portion and a non-disposable portion. The disposable portion and non-disposable portion can be connected to each other by a coupler. The disposable portion can include a capillary tube or other suitable Joule-Thompson expansion element to expand refrigerant in order to form ice balls on a conductive freeze tip for performing a cryothermal treatment. A vacuum-insulated annular jacket can surround both the disposable portion and the non-disposable portion to prevent and/or substantially eliminate heat transfer between the refrigerant and the body or ambient air at any portion of the cryoprobe other than the conductive freeze tip.

In yet another aspect of the present disclosure, a cryosurgical system can utilize cryoprobes having disposable portions. The cryosurgical system can include a control console that directs refrigerant from one or more compressors into one or more cryoprobes and receives returned refrigerant through a flexible line. Cryoprobes can each include a generally permanent, non-disposable portion attached to the cryosurgical system that can be connected via a coupler to various disposable portions usable for individual cryosurgical applications.

The above summary of the various representative embodiments of the invention is not intended to describe each illustrated embodiment or every implementation of the invention. Rather, the embodiments are chosen and described so that others skilled in the art may appreciate and understand the principles and practices of the invention. The figures in the detailed description that follows more particularly exemplify these embodiments.

### BRIEF DESCRIPTION OF THE FIGURES

These as well as other objects and advantages of this invention, will be more completely understood and appreciated by referring to the following more detailed description of the presently preferred exemplary embodiments of the invention in conjunction with the accompanying drawings of which:

FIG. 1 is a side view of an embodiment of a cryosurgical system according to the present disclosure;

FIG. 2 is a perspective view of an embodiment of a cryoprobe according to the present disclosure; and

FIG. 3 is a cross-sectional view of an embodiment of a cryoprobe according to the present disclosure.

### DETAILED DESCRIPTION OF THE FIGURES

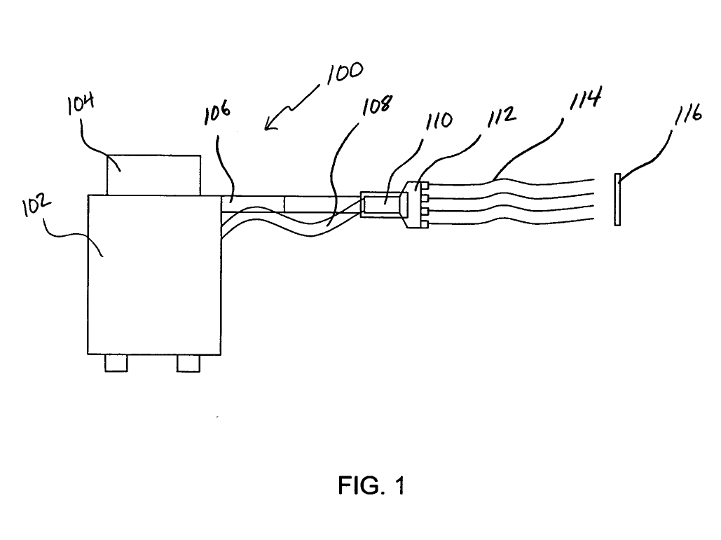

A closed loop cryosurgical system 100 according to the present disclosure is illustrated generally in FIG. 1. Cryosurgical system 100 can include a refrigeration and control console 102 with an attached display 104. Control console 102 can contain a primary compressor to provide a primary pressurized, mixed gas refrigerant to the system and a secondary compressor to provide a secondary pressurized, mixed gas refrigerant to the system. The use of mixed gas refrigerants is generally known in the art to provide a dramatic increase in cooling performance over the use of a single gas refrigerant. Control console 102 can also include controls that allow for the activation, deactivation, and modification of various system parameters, such as, for example, gas flow rates, pressures, and temperatures of the mixed gas refrigerants. Display 104 can provide the operator the ability to monitor, and in some embodiments adjust, the system to ensure it is performing properly and can provide real-time display as well as recording and historical displays of system parameters. One exemplary console that can be used with an embodiment of the present invention is used as part of the Her Option® Office Cryoablation Therapy available from American Medical Systems of Minnetonka, Minn.

With reference to FIG. 1, the refrigerant is transferred from control console 102 to a cryostat heat exchanger module 110 through a flexible line 108. The cryostat heat exchanger module 110 can include a manifold portion 112 that transfers refrigerant into and receives refrigerant out of one or more cryoprobes 114. The cryostat heat exchanger module 110 and cryoprobes 114 can also be connected to the control console 102 by way of an articulating arm 106, which can be use to manually or automatically position the cryostat heat exchanger module 110 and cryoprobes 114. Although depicted as having the flexible line 108 as a separate component from the articulating arm 106, cryosurgical system 100 can incorporate the flexible line 108 within the articulating arm 106. A positioning grid 116 can be used to properly align and position the cryoprobes 114 for patient insertion.

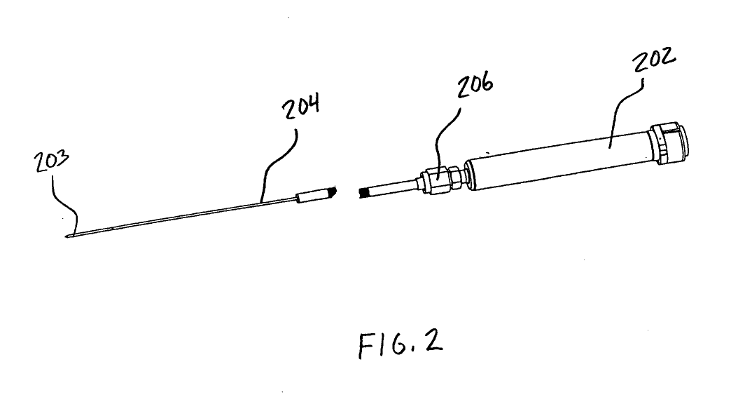

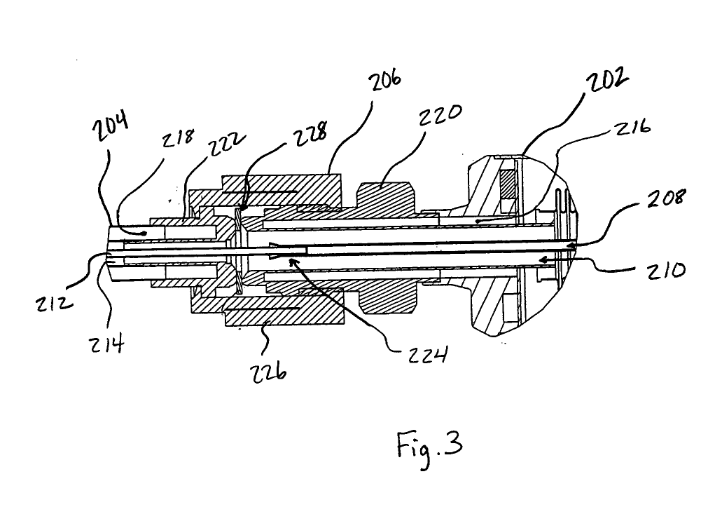

A representative cryoprobe 200 according to the present disclosure is depicted in FIGS. 2 and 3. Cryoprobe 200 can comprise a non-disposable base portion 202 and a disposable end portion 204 that can connect to one another via a coupler 206. Disposable end portion 204 can include a capillary tube or other Joule-Thompson expansion element. Refrigerant can flow through capillary tube and be isenthalpically expanded to further reduce the refrigerant's temperature such that an ice ball is formed on a conductive freeze tip 203, which is subsequently used to perform a cryothermal treatment. After cryothermal treatment has been completed, disposable end portion 204 can be disconnected from non-disposable base portion 202 at coupler 206 and a new, sterile disposable end portion 204 can be attached for a subsequent cryosurgical procedure.

As illustrated in FIG. 3, coupler 206 can connect coaxially arranged high pressure refrigerant pathway 208 and low pressure refrigerant pathway 210 in non-disposable base portion 202 with coaxial high pressure refrigerant pathway 212 and low pressure refrigerant pathway 214 in disposable end portion 204 so that refrigerant can flow between non-disposable base portion 202 and disposable end portion 204. High pressure pathways 208, 212 and low pressure pathways 210, 214 can have a slip-fit seal 224 that allows a controlled leak between the pathways.

A pair of vacuum-insulated annular jackets 216, 218 can surround high pressure pathways 208, 212 and low pressure pathways 210, 214 so as to insulate the refrigerant as it circulates through the cryoprobe 200. Vacuum insulation can be maintained by getters within the sealed annular spaces 216, 218. Alternatively, insulation can comprise aerogel or foam. Insulation can reduce and substantially eliminate heat transfer between the refrigerant within the cryoprobe 200 and the surrounding body/ambient air.

Coupler 206 can seal the high and low pressure refrigerant pathways from the environment with a pair of metal face seal fittings 220, 222. One exemplary face seal fitting that can be used with embodiments of the present invention to provide a reliable, low temperature seal is a VCR® face seal fitting available from Swagelok Fluid Systems Technologies of Solan, Ohio. Face seal fittings 220, 222 can be sealed together with a coupling nut 226. Coupling nut 226 can be configured to be tightened manually or with an automated mechanism. A layer of insulation can optionally be provided around the coupling nut 226 and/or face seal fittings 220, 222 to reduce and/or substantially eliminate heat transfer with the ambient environment. A metal gasket 228 can be captured between the face seal fittings 220, 222 to enhance the seal. Gasket 228 can include an insulating collar to further reduce heat transfer through the fittings and seal. Preferably, the gasket 228, face seal fittings 220, 222, and nut 226 are comprised of the same material. In this manner, each component of the coupler 206 possesses the same thermal expansion properties which allows the integrity of the seal to be maintained as the temperature within the cryosurgical system 100 fluctuates. In some embodiments, face seal fittings 220, 222, nut 226 and gasket 228 can comprise a metal such as, for example, stainless steel, nickel, copper and the like.

Disposable cryoprobe 200 provides for a sterile instrument without the need for a separate sheath or cover. This allows for smaller and more efficient cryoprobes. Use of a detachable cryoprobe 200 also provides a more versatile cryosurgical system 100 because variously configured cryoprobes for different applications can be easily attached and detached. For instance, disposable end portion 204 can be selectively sized and shaped to correspond with designated types and areas of cryosurgical treatment.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

1. A coupler for use in a closed-loop cryosurgical system, comprising:
a first face seal fitting;
a second face seal fitting; and
a coupling nut sealing the first and second face seal fittings together,
wherein the coupler is configured to link a refrigerant pathway of a disposable cryoprobe portion and a refrigerant pathway of a non-disposable cryoprobe portion so refrigerant can flow freely between them.

2. The coupler of claim 1, further comprising a gasket captured between the first and second face seal fittings.

3. The coupler of claim 2, wherein the gasket includes an insulating collar.

4. The coupler of claim 2, wherein the first and second face seal fittings, the coupling nut, and the gasket are all comprised of the same material.

5. The coupler of claim 4, wherein the material is selected from the group consisting of: stainless steel, nickel and copper.

6. The coupler of claim 1, further comprising insulation surrounding the first and second face seal fittings and coupling nut.

7. A probe for use in a cryosurgical procedure, comprising:
a disposable end portion including at least one refrigerant pathway;
a non-disposable base portion including at least one refrigerant pathway; and
a coupler configured to connect the refrigerant pathway of the disposable portion to the refrigerant pathway of the non-disposable portion.

8. The probe of claim 7, wherein the coupler includes a pair of face seal fittings and a coupling nut configured to seal the face seal fittings together.

9. The probe of claim 8, further comprising a gasket adapted to seal between the pair of face seal fittings.

10. The probe of claim 9, wherein the gasket includes an insulating collar.

11. The probe of claim 9, wherein the pair of face seal fittings, the coupling nut, and the gasket are all comprised of the same material.

12. The probe of claim 7, wherein the disposable end portion includes a conductive freeze tip and an expansion element whereby the expansion element is configured to expand refrigerant flowing therethrough to form an ice ball on the conductive freeze tip for performing a cryosurgical procedure.

13. The probe of claim 7, wherein the disposable portion and the non-disposable portion each include a pair of coaxial refrigerant pathways that are interconnected by the coupler.

14. The probe of claim 13, wherein the coaxial pathways in the disposable portion and non-disposable portion are surrounded by an insulated annular jacket.

15. A closed-loop cryosurgical system comprising:
a console having a primary compressor for pressurizing a high pressure primary refrigerant and a secondary compressor for pressurizing a secondary high pressure refrigerant;
one or more cryoprobes fluidly connected to the console, each cryoprobe comprising a disposable end portion and a non-disposable base portion; and
a coupler connecting one or more refrigerant pathways in each disposable portion to one or more refrigerant pathways in a non-disposable portion.

16. The system of claim 16, wherein the coupler includes a pair of face seal fittings sealed together with a coupling nut.

17. The system of claim 16, further comprising a gasket captured between the face seal fittings.

18. The system of claim 17, wherein the gasket includes an insulating collar.

19. The system of claim 17, wherein the face seal fittings, nut, and gasket are all comprised of the same material.

20. The probe of claim 15, wherein the disposable portion and the non-disposable portion each include a pair of coaxial refrigerant pathways that are connected by the coupler.

21. A method of performing a cryosurgical procedure comprising:
providing a cryosurgical system including a non-disposable cryoprobe portion;
connecting a disposable cryoprobe portion to the non-disposable cryoprobe portion with a coupler;
circulating refrigerant through the cryosurgical system;
freezing selected tissue with the disposable cryoprobe portion;
detaching the disposable cryoprobe portion from the non-disposable cryoprobe portion; and
discarding the disposable cyroprobe portion.

22. The method of claim 21, wherein the step of connecting a disposable cryoprobe portion to the non-disposable cryoprobe portion includes tightening a coupling nut over a pair of face seal fittings.
